(19) United States
(12) Patent Application Publication
(10) Pub. No.: US 2025/0159458 A1
(43) Pub. Date: May 15, 2025

(54) ROAMING FOR CROWDSOURCED INTERNET OF THINGS (IOT)

(71) Applicant: Telefonaktiebolaget LM Ericsson (publ), Stockholm (SE)

(72) Inventors: Serdar SAHIN, Plano, TX (US); Jacob THOMAS, McKinney, TX (US); Krishna MOHAN MENON, Bangalore (IN); Mayur MEHTA, Plano, TX (US); Juan Felipe GAMEZ, Bogota (CO)

(73) Assignee: Telefonaktiebolaget LM Ericsson (publ), Stockholm (SE)

(21) Appl. No.: 18/839,406

(22) PCT Filed: Apr. 22, 2022
(86) PCT No.: PCT/IB2022/053759

§ 371 Date: Aug. 16, 2024

Related U.S. Application Data
(60) Provisional application No. 63/311,883, filed on Feb. 18, 2022.

(51) Int. Cl. H04W 8/08; H04W 4/029; H04W 84/18

(52) U.S. Cl. CPC H04W 8/08; H04W 4/029; H04W 84/18

(57) ABSTRACT

A crowdsourced Internet of Things (IoT) solution is described. A user equipment (UE) receives a message from a transmitting device which is associated with a first organization while the user equipment is associated with a second organization. The UE determines whether roaming is allowed for the transmitting device from the first organization to the second organization. If roaming is allowed, the UE transmits at least an identifier of the transmitting device and location information of the UE to a roaming exchange for transmission to an IoT platform of the first organization. If roaming is not allowed, the UE ignores the message from the transmitting device.

### CROSS-REFERENCE TO RELATED APPLICATIONS

This application claims the benefit of U.S. Provisional Application No. 63/311,883, filed Feb. 18, 2022, which is hereby incorporated by reference.

### TECHNICAL FIELD

Embodiments of the invention relate to the field of Internet-of-Things (IoT); and more specifically, to roaming for crowdsourced IoT.

### BACKGROUND ART

For Low-Power Wide-Area (LPWA) IoT, there are various technologies available including cellular (e.g., Cat-M and NB-IoT), and non-cellular (e.g., LoRa and SigFox). LTE-Machine Type Communication (commonly referred to as LTE-M or Cat-M) and Narrowband Internet of Things (NB-IoT) are 3GPP cellular connectivity standards for IoT devices. Cat-M provides relatively higher speed, has lower range, and uses more battery compared to NB-IoT. Long Range (LoRa) is a proprietary low-power wide-area network modulation technique. It uses license free bands, but the network infrastructure needs to be in place to support the communications. It is mostly used for indoor or limited outdoor enterprise IoT use case scenarios. SigFox is another proprietary low-power wide-area network technology.

There are also alternative crowdsourced IoT solutions that use a Bluetooth based crowdsourced approach to target overlapping use cases with LPWA, such as asset tracking in a wide area. Example products that use such crowdsourced IoT solutions include Apple AirTag, Amazon Sidewalk, Nodle.io, and Tile.

As an example, a mobile device of a particular company may listen to Bluetooth Low Energy (BLE) advertisements from a BLE tag of a BLE device of that company. When the mobile device detects a BLE advertisement, the mobile device adds its Global Positioning System (GPS) location with an identifier of the BLE tag to a notification that is forwarded to a server of the company. Since there may be many (on the order of millions) of compatible devices, the BLE device that is being tracked can be located if there is a compatible mobile device within the range of that BLE device.

### SUMMARY OF THE INVENTION

A crowdsourced Internet of Things (IoT) solution is described. In one aspect a method is performed by a User Equipment (UE) as part of the crowdsourced IoT solution. The method includes the UE receiving a first message from a first transmitting device; determining, from the first message, that the first transmitting device is associated with a first organization, and where the user equipment is associated with a second organization; determining, using a data structure installed on the user equipment, that roaming is allowed for the first transmitting device from the first organization to the second organization, and responsive to this determination, transmitting at least an identifier of the first transmitting device and location information of the user equipment to a roaming exchange for transmission to an IoT platform of the first organization. The method further includes the UE receiving a second message from a second transmitting device; determining, from the second message, that the second transmitting device is associated with a third organization; and determining, using the data structure installed on the user equipment, that roaming is not allowed for the second transmitting device from the third organization to the second organization, and responsive to this determination, ignoring the received second message. The first and second messages may be Bluetooth Low Energy (BLE) advertisement messages. The location information may include a Global Positioning System (GPS) location of the UE. Determining that roaming is allowed for the first transmitting device may include determining an organization identifier that identifies the first organization; and comparing the determined organization identifier against the data structure to determine that roaming is allowed for the first organization to the second organization. Determining that roaming is allowed for the first transmitting device may further include determining that a roaming permission flag included in the first message indicates that roaming is allowed for the first transmitting device. Determining that roaming is allowed for the first transmitting device may further include determining that multiple roaming permission flags included in the first message indicate that roaming is allowed for the first transmitting device for the second organization. Determining that roaming is not allowed for the second transmitting device may include determining that a roaming permission flag included in the second message indicates that roaming is not allowed for the second transmitting device. Determining that roaming is not allowed for the second transmitting device may further include determining that multiple roaming permission flags included in the second message indicates that roaming is not allowed for the second transmitting device for the second organization.

In further aspects, one or more embodiments of a non-transitory computer-readable medium or distributed media containing computer-executable program instructions or code portions stored thereon are disclosed for performing one or more embodiments of the methods of the present invention when executed by a processor entity of an apparatus, a user equipment, or other computing device. Further features of the various embodiments are as claimed in the dependent claims.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary system for a crowdsourced IoT platform according to an embodiment.

FIG. 2 shows a sequence diagram illustrating a crowdsourced IoT platform according to an embodiment.

FIG. 3 is a flow diagram that illustrates exemplary operations for a crowdsourced IoT platform according to an embodiment.

FIG. 4 shows an example of a communication system in accordance with some embodiments.

FIG. 5 shows a UE in accordance with some embodiments.

FIG. 6 shows a network node in accordance with some embodiments.

FIG. 7 is a block diagram of a host, which may be an embodiment of the host of FIG. 4, in accordance with various aspects described herein.

FIG. 8 is a block diagram illustrating a virtualization environment in which functions implemented by some embodiments may be virtualized.

FIG. 9 shows a communication diagram of a host communicating via a network node with a UE over a partially wireless connection in accordance with some embodiments.

### DETAILED DESCRIPTION

Roaming for crowdsourced IoT is described in an embodiment. There currently exist certain challenge(s) with existing crowdsourced IoT solutions. The existing crowdsourced IoT solutions are designed to work as one-organization architectures that do not allow them to interoperate or let other actors to act as organizations as part of the underlying ecosystem. With an analogy to a cellular system, this would be equivalent to having a cellular system that does not allow any interoperability between different operators.

Certain aspects of the disclosure and their embodiments may provide solutions to these or other challenges. The proposed solution allows each organization (e.g., each cellular operator) to control their own wireless based crowdsourced IoT network while also allowing the transmitting devices to roam from one operator (or other entities) to another to increase coverage.

The solution enables roaming between different instances of a crowdsourced IoT network. Each instance of the crowdsourced IoT network improves existing solutions by allowing roaming between devices from different organizations.

In an embodiment, a lightweight authorization mechanism is implemented in a user equipment (UE) device that detects messages from transmitting devices (e.g., broadcast messages from IoT devices). This UE device is sometimes referred herein as a UE detecting device or a detecting device. As an example, the UE detecting device may be a mobile phone. The lightweight authorization mechanism may limit excessive battery consumption.

In an embodiment of the lightweight authorization scheme, a unique identifier mapping for transmitting devices is used for each organization (e.g., telecom operator or enterprise) operating the solution. This unique identifier is sometimes referred herein as an organization identifier (ID). For example, for a telecom operator, the Mobile Country Code (MCC)/Mobile Network Code (MNC) that is unique to an operator is mapped to the IEEE assigned Company ID, or used as part of the remaining address space of the transmitting device, to achieve a unique identifier (a unique organization ID) for that telecom operator. For a non-telecom enterprise, a unique ID mapping can be implemented. The organization ID may be part of an address space (e.g., MAC address) assigned to each transmitting device of that organization.

The UE detecting device includes one or more data structures, known as a filter herein, that it uses to determine which messages to process based on the information included in those messages (e.g., the organization ID included in each message). The data of the filter may be received from a server (e.g., a roaming control server). For instance, depending on roaming arrangements between the organizations, the UE detecting device may use the filter to process messages from different organizations according to the roaming arrangements. White, black, or gray filtering methods can be used to manage access. The gray list includes identifiers of questionable transmitting devices (e.g., suspected faulty equipment, potential fraud), and a different policy or logging may be applied to those transmitting devices.

Unlike cellular roaming technologies that apply permissions based on an individual basis (e.g., each SIM card can be provided with a different set of permissions at HLR/HSS), in embodiments of the solution the permissions are applied at the organization level to reduce processing load in the UE detecting devices to reduce battery consumption. Further, in an embodiment, each transmitting device can have multiple organization IDs that are rotated/shuffled to prevent playback attacks.

The lightweight authorization mechanism may include a flag that defines roaming permission (a roaming permission flag). The roaming permission flag may be added to the address space of the transmitting device or otherwise included in the broadcast message. The roaming permission flag indicates whether roaming is allowed for that particular device. For example, “1” may indicate roaming is allowed and “0” may indicate that roaming is not allowed (or vice versa). The roaming permission flag allows an organization to configure some transmitting devices for roaming and other devices that cannot roam. The transmitting devices can be configured to allow changing their IDs by the organization, and as such roaming permissions turned on and off as needed.

The lightweight authorization mechanism may include multiple roaming permission flags that define roaming permission. The multiple roaming permission flags may be added to the address space of the transmitting device or otherwise included in the message. These roaming permission flags indicate whether roaming is allowed for certain device to roam to certain set of one or more organizations. These roaming permission flags allow an organization to have transmitting devices that can, or cannot, roam and specify the set of organization(s) to which the permission applies For example, “00” may indicate no roaming; “01” may indicate roaming is allowed to a first set of one or more organizations; “10” may indicate roaming is allowed to a second set of one or more organizations; and “11” may indicate roaming is allowed for all organizations. The transmitting devices can be configured to allow their roaming permission flags to be changed. The lightweight authorization may include even further number of flags to have even more granularity.

A roaming control server controls roaming permissions (e.g., which devices of an organization can roam into an IoT system of other organization(s)). Each operating entity (e.g., telecom operators or enterprises) may host their own roaming control server. The roaming control server may be in a distributed architecture.

A backend roaming exchange can track each case of roaming transfer and which transmitting device roamed into which organization's UE detecting device; and any financial settlements are handled based on this information.

Both the distributed roaming control server and backend roaming exchange can be implemented using blockchain ledger and smart contracts to ensure immutability and auditability of the roaming agreements and settlement charges.

Certain embodiments may provide one or more of the following technical advantage(s). The crowdsourced IoT solution can extend crowdsourced IoT both to consumers and to enterprises. This solution can be platform independent (e.g., not locked into one technology ecosystem).

By enabling roaming between the instances of the crowdsourced IoT solution (for example, each organization may have their own offering), the coverage of the solution can be greatly increased.

Some of the embodiments contemplated herein will now be described more fully with reference to the accompanying drawings. Embodiments are provided by way of example to convey the scope of the subject matter to those skilled in the art.

A lightweight authorization scheme is used to control whether transmitting devices can roam from one organization (e.g., one operator) to another organization (e.g., another operator). To prevent excessive battery consumption on the UE detecting devices, the authorization scheme is easy to implement and execute. In our solution, a unique identifier for transmitting devices that belong to each organization is used. For instance, organization A's transmitting devices have an ID that uniquely identifies them; and organization B's transmitting devices have an ID that uniquely identifies them.

In an embodiment, the transmitting devices are BLE devices that periodically transmit BLE advertisements; and the UE detecting devices are capable of detecting the BLE advertisements. An identifier of the organization with which that BLE device is associated may be encoded in a MAC address of the BLE device, included in a payload of the BLE advertisement message, included in an extension to the BLE advertisement message, or a combination thereof. The identifier may be an MCC/MNC tuple, for instance and included in a 48-bit extended unique identifier as the MAC address. The identifier may be a unique company ID provided by IEEE. The message may also include an identifier that identifies the product device line. The UE detecting device uses a filter to determine what BLE advertisement messages to process based at least in part on the identifier included in the BLE advertisement message.

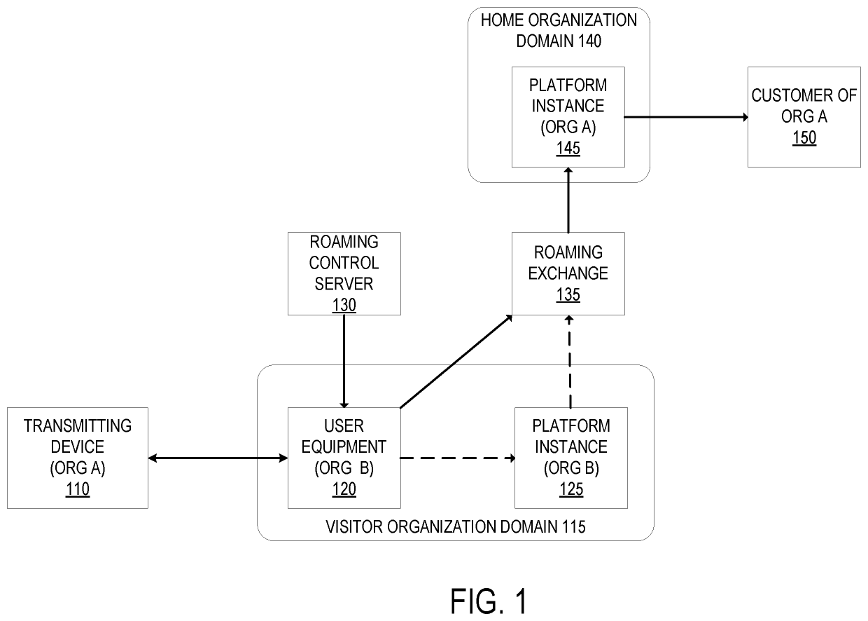

FIG. 1 illustrates an exemplary system for a crowdsourced IoT platform according to an embodiment. The solution enables roaming between different instances of a crowdsourced IoT network. Each instance of the crowdsourced IoT network improves existing solutions by allowing roaming between transmitting devices from different organizations. Each organization may be an entity such as a telecom operator, a device manufacturer/seller, or other entity.

In the example of FIG. 1, the transmitting device 110 is associated with an organization A. The home domain of the transmitting device 110 is represented by the home organization domain 140. In the example of FIG. 1, the transmitting device 110 is not within range of any devices of its home domain but is within range of a device of a visitor domain (e.g., the user equipment detecting device 120). The transmitting device may take the form of an IoT device. For instance, the transmitting device 110 may take the form of a tracking device or a key finder.

The transmitting device 110 is configured to transmit messages over a wireless technology that uses a broadcast mechanism, such as Bluetooth. In an example, the transmitting device 110 periodically broadcasts a message, such as a BLE advertisement. The message includes information that allows a detecting device, such as the user equipment detecting device 120, determine the identity of the organization with which the transmitting device 110 is associated. For instance, an identifier of the organization may be encoded in a MAC address of the transmitting device 110, included in a payload of the message, included in an extension to the message, or a combination thereof. The identifier may be an MCC/MNC tuple, for instance. The identifier may be a unique company ID provided by IEEE. The message may also include an identifier that identifies the product device line.

In an embodiment, the message may include one or more roaming permission flags, such as in the MAC address of the message. If one roaming permission flag is used, it indicates whether roaming is allowed for that particular device. For example, “1” may indicate roaming is allowed and “0” may indicate that roaming is not allowed (or vice versa). The single roaming permission flag allows an organization to configure some transmitting devices for roaming and other transmitting devices that cannot roam. If multiple roaming permission flags are used, they indicate whether roaming is allowed for certain devices to roam to certain set of one or more organizations. These roaming permission flags allow an organization to have transmitting devices that can, or cannot, roam and specify the set of organization(s) to which the permission applies For example, “00” may indicate no roaming; “01” may indicate roaming is allowed to a first set of one or more organizations; “10” may indicate roaming is allowed to a second set of one or more organizations; and “11” may indicate roaming is allowed for all organizations. The transmitting devices can be configured to allow their roaming permission flags to be changed.

The UE detecting device 120 includes crowdsourced IoT software. Examples of a UE detecting device include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

The UE detecting device 120 periodically receives roaming permissions and/or updates to roaming permissions from the roaming control server 130. The UE detecting device 120 may periodically synchronize the roaming permissions with the roaming control server 130. The roaming control server 130 can be physically part of a roaming exchange or may be physically distinct.

The roaming permissions define what organizations and optionally which devices of that organization are allowed to roam with devices from organization B. The roaming permissions are stored in a data structure, known herein as a filter, that is used to determine which messages to process based on the incoming messages from the transmitting devices. For instance, depending on roaming arrangements between the organizations, the UE detecting device may use the filter to process messages from different organizations according to the roaming arrangements. White, black, or gray filtering methods can be used to manage access. A whitelist may include organization identifier(s) that identify organization(s) for which roaming is allowed (and all others are not allowed), device line identifier(s) that identify product device line(s) for which roaming is allowed (and all others are not allowed), and/or device identifier(s) that identify specific transmitting device(s) for which roaming is allowed (and all others are not allowed). A blacklist may include the organization identifier(s) that identify organization(s) for which roaming is not allowed (and all others are allowed), device line identifier(s) that identify product device line(s) for which roaming is not allowed (and all others are allowed), and/or device identifier(s) that identify specific transmitting device(s) for which roaming is not allowed (and all others are allowed). A gray list may include organization identifier(s), device line identifier(s), and/or device identifier(s) of questionable transmitting device(s) (e.g., suspected faulty equipment, potential fraud), and a different policy or logging may be applied to those transmitting device(s). The lists may be used in combination. For instance, the filter may include a whitelist that includes an organization identifier for which roaming is allowed and a blacklist that excepts certain device identifiers and/or device line identifiers of that organization.

In the example of FIG. 1, the UE detecting device 120 is associated with an organization B, which is different from organization A. As previously described, the transmitting device 110 is not within range of its home organization domain 140. However, the transmitting device 110 is within range of the UE detecting device 120 which is part of the visitor organization domain 115. When in range of the transmitting device 110, the UE detecting device 120 receives the broadcast message from the transmitting device 110, such as a BLE advertisement. The UE detecting device 120 determines an identifier of the organization based on the received broadcast message. For instance, if the identifier is encoded in the MAC address and/or payload of the message, the UE detecting device 120 accesses the appropriate bytes to extract the identifier of the organization. If the organization identifier is in an extension of the broadcast message, the UE detecting device 120 determines the identifier from the extension.

The UE detecting device 120 determines, using the filter installed on the UE detecting device 120, whether roaming is allowed for the transmitting device 110 from organization A to organization B. The UE detecting device 120 may apply a combination of one or more of the identifier(s) extracted from the message (e.g., the organization identifier, the device line identifier, and/or the device identifier) and/or one the roaming permission flag(s) to determine whether roaming is allowed for the transmitting device 110. For instance, the UE detecting device 120 may apply the organization identifier to the filter to determine whether roaming is allowed for that organization. In an embodiment where the message includes a device line identifier, the UE detecting device 120 applies the organization identifier and/or the device line identifier to the filter to determine whether roaming is allowed for the organization and for that device line. In an embodiment, the UE detecting device 120 applies the organization identifier, the device line identifier, and/or the device identifier to the filter to determine whether roaming is allowed for that particular transmitting device 110. If roaming is not allowed, then the UE detecting device 120 ignores the message. If roaming is allowed, then in an embodiment where a roaming permission flag is not used, the UE detecting device 120 transmits at least an identifier of the transmitting device 110 (e.g., the MAC address or other device identifier) and a payload to a roaming exchange 135 that in turn sends the data to the platform instance 145 of the home organization domain 140. The payload may include location information (e.g., as determined by GPS or other location services) of the UE detecting device 120, and/or other data of the UE detecting device 120 (e.g., sensor data such as temperature, movement detection, pressure, etc.). The UE detecting device 120 may encrypt the data that is sent to the roaming exchange 135.

In an embodiment where one or more roaming permission flags are used and the UE detecting device 120 determines that roaming is allowed for the identified organization, the UE detecting device 120 extracts the roaming permission flag(s) to determine whether roaming is allowed for the particular transmitting device 110. For example, if one roaming permission flag is used, that roaming permission flag indicates whether roaming is allowed for that particular transmitting device 110. The UE detecting device 120 checks whether that roaming permission flag indicates whether roaming is allowed for the transmitting device 110. If multiple roaming permission flags are used, those roaming permission flags indicate whether roaming is allowed for the transmitting device 110 to roam to certain set of one or more organizations. In such a case, the UE detecting device 120 checks whether those roaming permission flags indicate whether roaming is allowed for the transmitting device 110 at organization B. In either case, if roaming is allowed, the UE detecting device 120 transmits at least an identifier of the transmitting device 110 (e.g., the MAC address or other device identifier) and a payload to a roaming exchange 135 that in turn sends the data to the platform instance 145 of the home organization domain 140. The payload may include location information (e.g., as determined by GPS or other location services) of the UE detecting device 120, and/or other data of the UE detecting device 120 (e.g., sensor data such as temperature, movement detection, pressure, etc.). If roaming is not allowed, then the UE detecting device 120 ignores the message.

In an embodiment, after determining that roaming is permitted, the UE detecting device 120 transmits at least the identifier of the transmitting device 110 and the payload to the platform instance 125 of the visitor organization domain 115. This payload may include location information (e.g., as determined by GPS or other location services) of the UE detecting device 120, and/or other data of the UE detecting device 120 (e.g., sensor data such as temperature, movement detection, pressure, etc.). The platform instance 125 forwards the data to the roaming exchange 135 that in turn sends the data to the platform instance 145 of the home organization domain 140. The platform instance 125 may track the number of roaming messages exchanged for the platform instance 145, which can be used for roaming settlements.

The platform instance 145 processes the data and may transmit the data to the customer of the organization A 150. As an example, if the transmitting device 110 is a tracking device, the UE detecting device 120 associated with organization B may add its location to the payload that is transmitted to the platform instance 145. The customer of organization A 150 may request the location information from the platform instance 145, which gives an approximate location of the transmitting device 110.

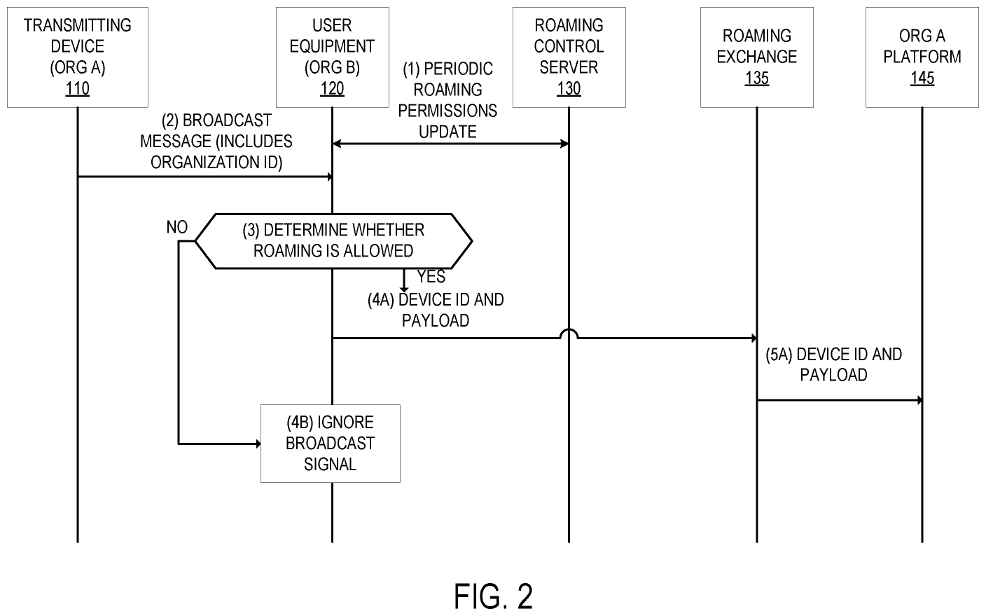

FIG. 2 shows a sequence diagram illustrating a crowdsourced IoT platform according to an embodiment. At operation 1, the UE detecting device 120 receives roaming permissions and/or updates to roaming permissions from the roaming control server 130, like as described with respect to FIG. 1. The roaming permissions may be periodically synched between the UE detecting device 120 and the roaming control server 130. The UE detecting device 120 stores these roaming permissions in a data structure, referred herein as a filter, like as described with respect to FIG. 1.

The transmitting device 110 periodically broadcasts messages such as advertisement messages. At operation 2, the transmitting device 110 broadcasts a message (e.g., an advertisement message) that is received by the UE detecting device 120. This broadcast message includes an organization identifier that identifies the organization with which the transmitting device 110 is associated. For instance, an identifier of the organization may be encoded in a MAC address of the transmitting device 110 included in the message, included in a payload of the message, included in an extension to the message, or a combination thereof. The identifier may be an MCC/MNC tuple, for instance. The identifier may be a unique company ID provided by IEEE. The message may also include an identifier that identifies the product device line. In the example of FIG. 2, the transmitting device 110 is associated with the organization A. The message may also include one or more roaming permission flags like as described with respect to FIG. 1.

The UE detecting device 120 processes the message to determine whether roaming is allowed. Processing the message includes the UE detecting device 120 determining, based on the received broadcast message, an identifier of the organization to which the transmitting device 110 belongs. For instance, if the identifier is encoded in the MAC address and/or payload of the message, the UE detecting device 120 accesses the appropriate bytes to extract the identifier of the organization. Processing the message further includes the UE detecting device 120 applying the organization identifier to the filter to determine whether roaming is allowed for that organization. For instance, the UE detecting device 120 may compare the identifier to the filter. Processing the message may further include the UE detecting device 120 analyzing the set of one or more roaming permission flags (if used) like as described with respect to FIG. 1 to determine whether roaming is allowed. If the UE detecting device 120 determines that roaming is not allowed, then operation 4B is performed where the UE detecting device 120 ignores the broadcast message.

If the UE detecting device 120 determines that roaming is allowed, then operation 4A is performed where the UE detecting device 120 transmits at least an identifier of the transmitting device 110 (e.g., the MAC address or other device identifier) and a payload to a roaming exchange 135 that in turn sends the data to the platform instance 145 of the home organization domain 140 at operation 5A. The payload may include location information (e.g., as determined by GPS or other location services) of the UE detecting device 120, and/or other data of the UE detecting device 120 (e.g., sensor data such as temperature, movement detection, pressure, etc.). The platform instance 145 processes the data and may transmit the data to the customer of the organization A 150. As an example, if the transmitting device 110 is a tracking device, the UE detecting device 120 associated with organization B may add its location to the payload that is transmitted to the platform instance 145. The customer of organization A 150 may request the location information from the platform instance 145, which gives an approximate location of the transmitting device 110.

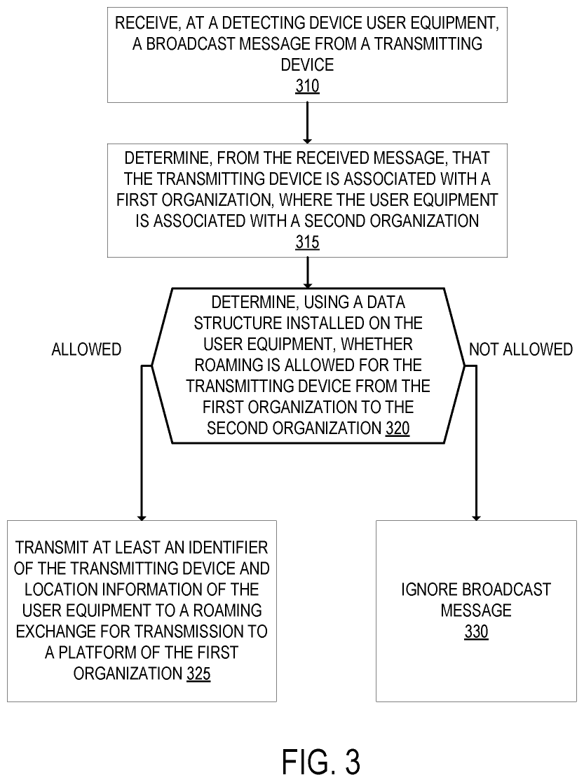

FIG. 3 is a flow diagram that illustrates exemplary operations for a crowdsourced IoT platform according to an embodiment. The operations described with respect to FIG. 3 are performed by a UE detecting device such as the UE detecting device 120. The operations of FIG. 3 are described with respect to the exemplary embodiment of FIG. 1. However, the operations of FIG. 3 can be performed by embodiments different from that of FIG. 1, and the exemplary embodiment of FIG. 3 can perform operations different from that of FIG. 3.

At operation 310, the UE detecting device 120 receives a broadcast message from a transmitting device 110. The broadcast message includes information that allows the UE detecting device 120 to determine an organization identifier that associates an organization with the transmitting device 110.

Next, at operation 315, the UE detecting device 120 determines, from the received message, that the transmitting device 110 is associated with a first organization. For instance, an organization identifier may be encoded in a MAC address of the transmitting device 110 (included in the broadcast message), included in a payload of the broadcast message, included in an extension to the broadcast message, or a combination thereof. The identifier may be an MCC/MNC tuple, for instance. The identifier may be a unique company ID provided by IEEE. The message may also include an identifier that identifies the product device line. If the organization identifier is encoded in the MAC address and/or payload of the message, the UE detecting device 120 accesses the appropriate bytes to extract the identifier of the organization. If the organization identifier is in an extension of the broadcast message, the UE detecting device 120 determines the identifier from the extension. The UE detecting device 120 is associated with a second organization which is different from the first organization. The received message may also include one or more roaming permission flags that may be extracted by the UE detecting device 120.

Next, at operation 320, the UE detecting device 120 determines, using a data structure installed on the UE detecting device 120, whether roaming is allowed for the transmitting device 110 from the first organization to the second organization. The data structure, known as a filter, is built from roaming permissions that may be periodically received from the roaming control server 130. The filter is used to determine which messages to process based on the incoming messages from the transmitting devices. The UE detecting device 120 may apply a combination of one or more of the identifier(s) extracted from the message (e.g., the organization identifier, the device line identifier, and/or the device identifier) and/or one the roaming permission flag(s) to determine whether roaming is allowed for the transmitting device 110. For instance, the UE detecting device 120 may apply the organization identifier to the filter to determine whether roaming is allowed for that organization. In an embodiment where the message includes a device line identifier, the UE detecting device 120 applies the organization identifier and/or the device line identifier to the filter to determine whether roaming is allowed for the organization and for that device line. In an embodiment, the UE detecting device 120 applies the organization identifier, the device line identifier, and/or the device identifier to the filter to determine whether roaming is allowed for that particular transmitting device 110. Determining whether roaming is allowed may include the UE detecting device 120 analyzing the set of one or more roaming permission flags (if used) like as described with respect to FIG. 1 to determine whether roaming is allowed.

If roaming is determined to be allowed, then at operation 325 the UE detecting device 120 transmits at least an identifier of the transmitting device 110 (e.g., the MAC address or other device identifier) and a payload to a roaming exchange 135 that in turn sends the data to the platform instance 145 of the home organization domain 140. The payload may include location information (e.g., as determined by GPS or other location services) of the UE detecting device 120, and/or other data of the UE detecting device 120 (e.g., sensor data such as temperature, movement detection, pressure, etc.). The platform instance 145 processes the data and may transmit the data to the customer of the organization A 150. As an example, if the transmitting device 110 is a tracking device, the UE detecting device 120 associated with organization B may add its location to the payload that is transmitted to the platform instance 145. The customer of organization A 150 may request the location information from the platform instance 145, which gives an approximate location of the transmitting device 110.

If roaming is not allowed, then the UE detecting device 120 ignores the message at operation 330.

While embodiments have described the UE detecting device determining whether roaming is allowed based on incoming messages from the transmitting devices and roaming permissions received from the roaming control server, in another embodiment, the UE detecting device transmits these broadcast messages to the roaming exchange, or other server, with the supplemental information provided by the UE detecting device (e.g., location information (e.g., as determined by GPS or other location services) of the UE detecting device, and/or other data of the UE detecting device (e.g., sensor data such as temperature, movement detection, pressure, etc.)). The roaming exchange, or other server, determines whether roaming is allowed. This determination may be like how the UE detecting device determines whether roaming is allowed as described herein. Alternatively, or additionally, the roaming exchange, or other server, may include a database that includes detailed settings for each transmitting device that has roamed into the visitor organization domain 115 (e.g., a device identifier), roaming permissions (e.g., this transmitting device is allowed to roam into organizations B, F, G, etc.), and an identity of the home organization domain. In such a case, the database may be populated with data (e.g., roaming permissions) from a server in the home organization domain 140. In either embodiment, the UE detecting device may not include the filter. In either embodiment, if roaming is allowed, the message (including the supplemental information provided by the UE detecting device) is transmitted to the platform instance of the organization of the transmitting device. In another embodiment, the UE detecting device performs an initial authorization based on the organization identifier included in the broadcast message from the transmitting device and if allowed, transmits the message (including supplemental information added by the UE detecting device as previously described) to the roaming exchange or other server for further processing.

Although embodiments have described the detecting device being a UE, in an embodiment the detecting device can be another type of device that detects wireless signals such as a WiFi Router, 3GPP Base Station (BTS, eNodeB, gNodeB, or future variants). In such an embodiment, the detecting device may perform like operations as described with respect to the UE detecting device 120.

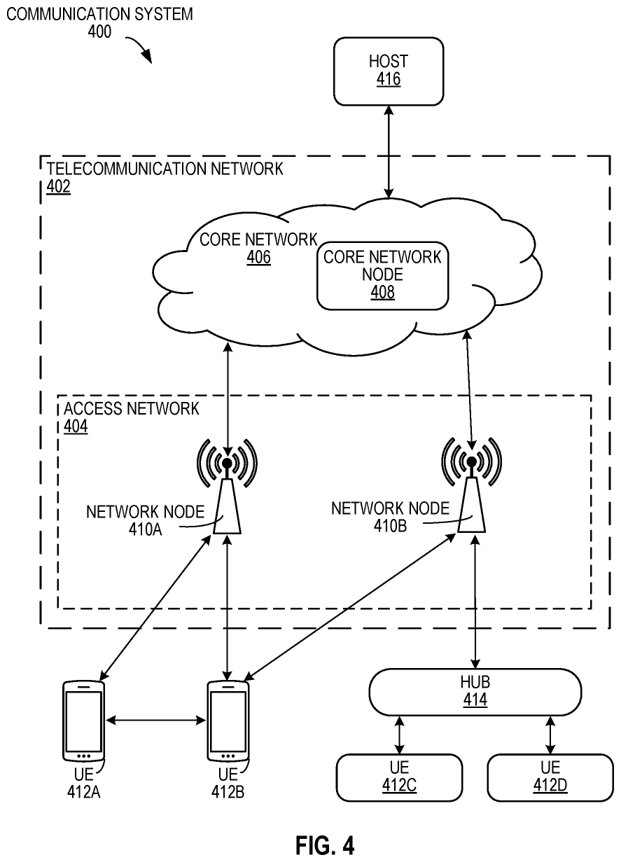

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3rd Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

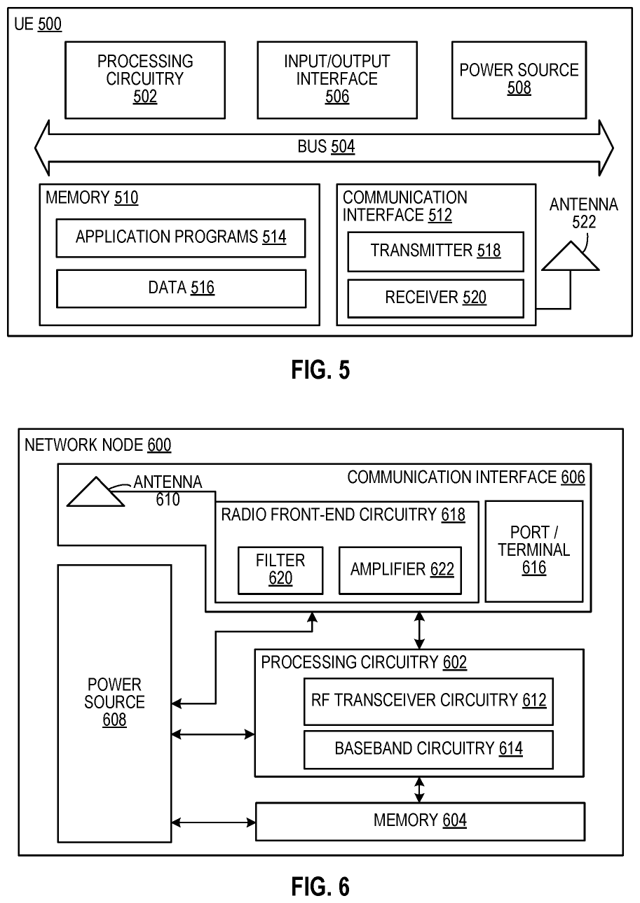

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment.

Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

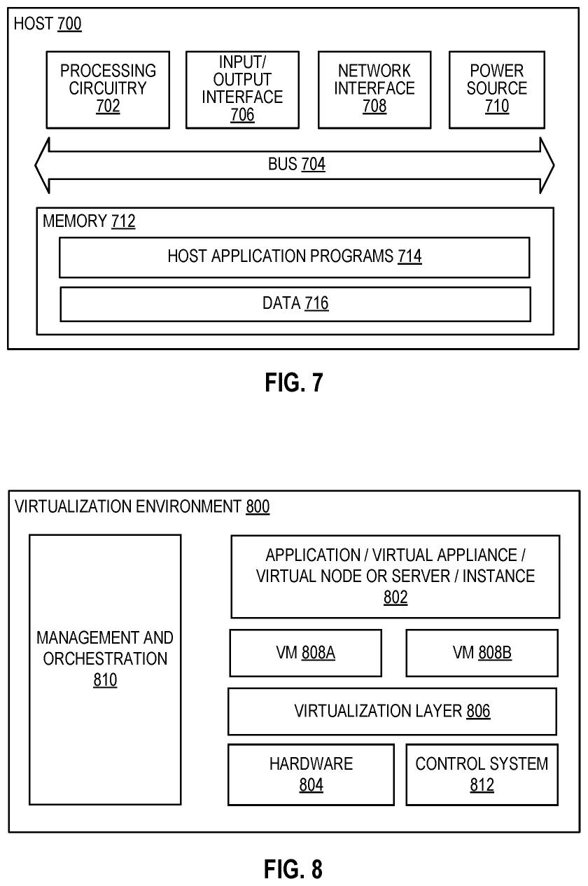

FIG. 7 is a block diagram of a host 700, which may be an embodiment of the host 416 of FIG. 4, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

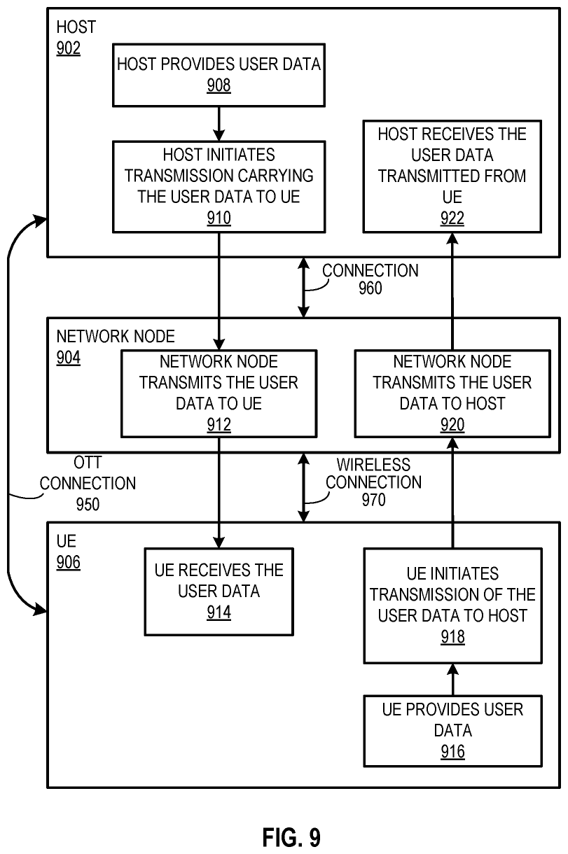

FIG. 9 shows a communication diagram of a host 902 communicating via a network node 904 with a UE 906 over a partially wireless connection in accordance with some embodiments. Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve the power consumption and thereby provide benefits such as extended battery lifetime.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiments

### Group A Embodiments

1. A method performed by a user equipment as part of a crowdsourced Internet of Things (IoT) solution, the method comprising:
receiving, at the user equipment, a first message from a first transmitting device;
determining, from the first message, that the first transmitting device is associated with a first organization, and wherein the user equipment is associated with a second organization;
determining, using a data structure installed on the user equipment, that roaming is allowed for the first transmitting device from the first organization to the second organization, and responsive to this determination,
   transmitting at least an identifier of the first transmitting device and location information of the user equipment to a roaming exchange for transmission to an IoT platform of the first organization;
receiving, at the user equipment, a second message from a second transmitting device;
determining, from the second message, that the second transmitting device is associated with a third organization; and
determining, using the data structure installed on the user equipment, that roaming is not allowed for the second transmitting device from the third organization to the second organization, and responsive to this determination, ignoring the received second message.

2. The method of embodiment 1, wherein the first message is a first Bluetooth Low Energy (BLE) advertisement message, and wherein the second message is a second BLE advertisement message.

3. The method of any previous embodiments, wherein the location information includes a Global Positioning System (GPS) location of the user equipment.

4. The method of any previous embodiments, wherein determining that roaming is allowed for the first transmitting device includes:
determining an organization identifier that identifies the first organization; and comparing the determined organization identifier against the data structure to determine that roaming is allowed for the first organization to the second organization.

5. The method of embodiment 4, wherein determining that roaming is allowed for the first transmitting device further includes:
determining that a roaming permission flag included in the first message indicates that roaming is allowed for the first transmitting device.

6. The method of embodiment 4, wherein determining that roaming is allowed for the first transmitting device further includes:
determining that a plurality of roaming permission flags included in the first message indicate that roaming is allowed for the first transmitting device for the second organization.

7. The method of any previous embodiments, wherein determining that roaming is not allowed for the second transmitting device includes determining that a roaming permission flag included in the second message indicates that roaming is not allowed for the second transmitting device.

8. The method of any previous embodiments, wherein determining that roaming is not allowed for the second transmitting device includes determining that a plurality of roaming permission flags included in the second message indicates that roaming is not allowed for the second transmitting device for the second organization.

9. The method of any of the previous embodiments, further comprising:
providing user data; and
forwarding the user data to a host via the transmission to the network node.

### Group B Embodiments

10. A method performed for a crowdsourced Internet of Things (IoT) solution, the method comprising:
receiving, at the user equipment, a first message from a first transmitting device, wherein the first transmitting device is associated with a first organization, and wherein the user equipment is associated with a second organization;
transmitting, by the user equipment, the first message received from the first transmitting device and first location information of the user equipment to a server;
determining, by the server, that roaming is allowed for the first transmitting device from the first organization to the second organization, and responsive to this determination, causing at least a first identifier of the first transmitting device and the first location information of the user equipment to be transmitted to an IoT platform of the first organization;
receiving, at the user equipment, a second message from a second transmitting device, wherein the second transmitting device is associated with a third organization;
transmitting, by the user equipment, the second message received from the second transmitting device and second location information of the user equipment to the server;
determining, by the server, that roaming is not allowed for the second transmitting device from the third organization to the second organization, and responsive to this determination, the server ignoring the received second message.

11. The method of embodiment 10, wherein the first message is a first Bluetooth Low Energy (BLE) advertisement message, and wherein the second message is a second BLE advertisement message.

12. The method of embodiments 10 or 11, wherein the first location information includes a first Global Positioning System (GPS) location of the user equipment, and wherein the second location information includes a second GPS location of the user equipment.

13. The method of any of embodiments 10-12, wherein determining, by the server, that roaming is allowed for the first transmitting device includes:
determining an organization identifier that identifies the first organization from the first message; and
comparing the determined organization identifier against a data structure that indicates that roaming is allowed for the first organization to the second organization.

14. The method of embodiment 13, wherein determining, by the server, that roaming is allowed for the first transmitting device further includes:
determining that a roaming permission flag included in the first message indicates that roaming is allowed for the first transmitting device.

15. The method of embodiment 13, wherein determining, by the server, that roaming is allowed for the first transmitting device further includes:
determining that a plurality of roaming permission flags included in the first message indicate that roaming is allowed for the first transmitting device for the second organization.

16. The method of any of embodiments 10-12, wherein determining, by the server, that roaming is allowed for the first transmitting device includes:
determining, from a data structure that is populated with roaming permissions provided by the first organization, that the first transmitting device is allowed to roam into the second organization.

17. The method of any of embodiments 10-15, wherein determining, by the server, that roaming is not allowed for the second transmitting device includes determining that a roaming permission flag included in the second message indicates that roaming is not allowed for the second transmitting device.

18. The method of any of embodiments 10-15, wherein determining, by the server, that roaming is not allowed for the second transmitting device includes determining that a plurality of roaming permission flags included in the second message indicates that roaming is not allowed for the second transmitting device for the second organization.

19. The method of any of embodiments 10-12, wherein determining, by the server, that roaming is not allowed for the second transmitting device includes:
determining, from the data structure that is populated with roaming permissions provided by the first organization, that the second transmitting device is not allowed to roam into the second organization.

### Group C Embodiments

20. A method performed by a user equipment as part of a crowdsourced Internet of Things (IoT) solution, the method comprising:
receiving, at the user equipment, a message from a transmitting device, wherein the transmitting device is associated with a first organization, and wherein the user equipment is associated with a second organization; and
transmitting, by the user equipment, the message received from the transmitting device and location information of the user equipment to a server to cause the server to:
determine whether roaming is allowed for the transmitting device from the first organization to the second organization, and
transmit at least an identifier of the transmitting device and the location information of the user equipment to an IoT platform of the first organization responsive to a determination that roaming is allowed for the transmitting device from the first organization to the second organization.

21. The method of embodiment 20, wherein the message is a Bluetooth Low Energy (BLE) advertisement message

22. The method of embodiments 20 or 21, wherein the location information includes a Global Positioning System (GPS) location of the user equipment.

### Group D Embodiments

23. A method performed by a server as part of a of a crowdsourced Internet of Things (IoT) solution, the method comprising:
receiving, at the server from a user equipment, first location information of the user equipment and a first message that is sourced from a first transmitting device, wherein the first transmitting device is associated with a first organization and the user equipment is associated with a second organization;
determining, by the server, that roaming is allowed for the first transmitting device from the first organization to the second organization, and responsive to this determination, causing at least a first identifier of the first transmitting device and the first location information of the user equipment to be transmitted to an IoT platform of the first organization;
receiving, at the server from the user equipment, second location information of the user equipment and a second message that is sourced from a second transmitting device, wherein the second transmitting device is associated with a third organization;
determining, by the server, that roaming is not allowed for the second transmitting device from the third organization to the second organization, and responsive to this determination, the server ignoring the received second message.

24. The method of embodiment 23, wherein the first message is a first Bluetooth Low Energy (BLE) advertisement message, and wherein the second message is a second BLE advertisement message.

25. The method of embodiments 23 or 24, wherein the first location information includes a first Global Positioning System (GPS) location of the user equipment, and wherein the second location information includes a second GPS location of the user equipment.

26. The method of any of embodiments 23-25, wherein determining, by the server, that roaming is allowed for the first transmitting device includes:
determining an organization identifier that identifies the first organization from the first message; and
comparing the determined organization identifier against a data structure that indicates that roaming is allowed for the first organization to the second organization.

27. The method of embodiment 26, wherein determining, by the server, that roaming is allowed for the first transmitting device further includes:

determining that a roaming permission flag included in the first message indicates that roaming is allowed for the first transmitting device.

28. The method of embodiment 26, wherein determining, by the server, that roaming is allowed for the first transmitting device further includes:
determining that a plurality of roaming permission flags included in the first message indicate that roaming is allowed for the first transmitting device for the second organization.

29. The method of any of embodiments 23-25, wherein determining, by the server, that roaming is allowed for the first transmitting device includes:
determining, from a data structure that is populated with roaming permissions provided by the first organization, that the first transmitting device is allowed to roam into the second organization.

30. The method of any of embodiments 23-28, wherein determining, by the server, that roaming is not allowed for the second transmitting device includes determining that a roaming permission flag included in the second message indicates that roaming is not allowed for the second transmitting device.

31. The method of any of embodiments 23-28, wherein determining, by the server, that roaming is not allowed for the second transmitting device includes determining that a plurality of roaming permission flags included in the second message indicates that roaming is not allowed for the second transmitting device for the second organization.

32. The method of any of embodiments 23-25, wherein determining, by the server, that roaming is not allowed for the second transmitting device includes:
determining, from the data structure that is populated with roaming permissions provided by the first organization, that the second transmitting device is not allowed to roam into the second organization.

### Group E Embodiments

33. A user equipment for a crowdsourced Internet-of-Things (IoT) solution, comprising: processing circuitry configured to perform any of the steps of any of the Group A embodiments; and power supply circuitry configured to supply power to the processing circuitry.

34. A user equipment (UE) for a crowdsourced Internet-of-Things (IoT) solution, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

35. A non-transitory computer-readable storage medium that provides instructions that, if executed by a processor, will cause said processor to perform any of the steps of any of the Group A embodiments.

36. A user equipment (UE) for a crowdsourced Internet-of-Things (IoT) solution, the UE comprising:
a processor; and
a non-transitory computer-readable storage medium that provides instructions that, if executed by the processor, cause the UE to perform any of the steps of any of the Group A embodiments.

37. A machine-readable medium comprising computer program code which when executed by a user equipment (UE) carries out any of the steps of any of the Group A embodiments.

38. A non-transitory computer-readable storage medium that provides instructions that, if executed by a processor, will cause said processor to perform the steps of any of the Group B embodiments.

39. A machine-readable medium comprising computer program code which when executed by a processor carries out any of the steps of any of the Group B embodiments.

40. A user equipment for a crowdsourced Internet-of-Things (IoT) solution, comprising: processing circuitry configured to perform any of the steps of any of the Group C embodiments; and power supply circuitry configured to supply power to the processing circuitry.

41. A user equipment (UE) for a crowdsourced Internet-of-Things (IoT) solution, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group C embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

42. A non-transitory computer-readable storage medium that provides instructions that, if executed by a processor, will cause said processor to perform any of the steps of any of the Group C embodiments.

43. A user equipment (UE) for a crowdsourced Internet-of-Things (IoT) solution, the UE comprising:
a processor; and
a non-transitory computer-readable storage medium that provides instructions that, if executed by the processor, cause the UE to perform any of the steps of any of the Group C embodiments.

44. A non-transitory computer-readable storage medium that provides instructions that, if executed by a processor, will cause said processor to perform the steps of any of the Group D embodiments.

45. A machine-readable medium comprising computer program code which when executed by a processor carries out any of the steps of any of the Group D embodiments.

### REFERENCES

Heinrich, A., Stute, M., Kornhuber, T., & Hollick, M. (2021). Who Can Find My Devices? Security and Privacy of Apple's Crowd-Sourced Bluetooth Location Tracking System. Proceedings on Privacy Enhancing Technologies, 2021, 227-245. arXiv: 2103.02282v1; available at https://arxiv.org/pdf/2103.02282.pdf
Nodle (November 2021). The Nodel Network: A New Economic Model to Free the Mobile Internet. Available at https://nodle.docsend.com/view/gjtn4jc
IEEE Standards Association, Guidelines for Use of Extended Unique Identifier (EUI), Organizationally Unique Identifier (OUI), and Company ID (CID), 2017 Aug. 3. Available at https://standards.ieee.org/content/dam/ieee-standards/standards/web/documents/tutorials/eui.pdf.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX
Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
Orthogonal Frequency Division Multiple Access OFDMA
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
Time of Arrival TOA
Tertiary Synchronization Signal TSS
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a user equipment as part of a crowdsourced Internet of Things solution, the method comprising:
receiving, at the user equipment, a first message from a first transmitting device;
determining, from the first message, that the first transmitting device is associated with a first organization, and wherein the user equipment is associated with a second organization;
determining, using a data structure installed on the user equipment, that roaming is allowed for the first transmitting device from the first organization to the second organization, and responsive to this determination,
transmitting at least an identifier of the first transmitting device and location information of the user equipment to a roaming exchange for transmission to an IoT platform of the first organization;
receiving, at the user equipment, a second message from a second transmitting device;
determining, from the second message, that the second transmitting device is associated with a third organization; and
determining, using the data structure installed on the user equipment, that roaming is not allowed for the second transmitting device from the third organization to the second organization, and responsive to this determination, ignoring the received second message.

2. The method of claim 1, wherein the first message is a first Bluetooth Low Energy (BLE) advertisement message, and wherein the second message is a second BLE advertisement message.

3. The method of claim 1, wherein the location information includes a Global Positioning System (GPS) location of the user equipment.

4. The method of claim 1, wherein determining that roaming is allowed for the first transmitting device includes:
determining an organization identifier that identifies the first organization; and
comparing the determined organization identifier against the data structure to determine that roaming is allowed for the first organization to the second organization.

5. The method of claim 4, wherein determining that roaming is allowed for the first transmitting device further includes:
determining that a roaming permission flag included in the first message indicates that roaming is allowed for the first transmitting device.

6. The method of claim 4, wherein determining that roaming is allowed for the first transmitting device further includes:
determining that a plurality of roaming permission flags included in the first message indicate that roaming is allowed for the first transmitting device for the second organization.

7. The method of claim 1, wherein determining that roaming is not allowed for the second transmitting device includes determining that a roaming permission flag included in the second message indicates that roaming is not allowed for the second transmitting device.

8. (canceled)

9. (canceled)

10. (canceled)

11. (canceled)

12. (canceled)

13. A non-transitory computer-readable storage medium that provides instructions that, if executed by a processor of a user equipment, will cause said user equipment to perform operations comprising:
receiving, at the user equipment, a first message from a first transmitting device;
determining, from the first message, that the first transmitting device is associated with a first organization, and wherein the user equipment is associated with a second organization;
determining, using a data structure installed on the user equipment, that roaming is allowed for the first transmitting device from the first organization to the second organization, and responsive to this determination,
transmitting at least an identifier of the first transmitting device and location information of the user equipment to a roaming exchange for transmission to an Internet of Things (IoT) platform of the first organization;
receiving, at the user equipment, a second message from a second transmitting device;
determining, from the second message, that the second transmitting device is associated with a third organization; and
determining, using the data structure installed on the user equipment, that roaming is not allowed for the second transmitting device from the third organization to the second organization, and responsive to this determination, ignoring the received second message.

14. The non-transitory computer-readable storage medium of claim 13, wherein the first message is a first Bluetooth Low Energy (BLE) advertisement message, and wherein the second message is a second BLE advertisement message.

15. The non-transitory computer-readable storage medium of claim 13, wherein the location information includes a Global Positioning System (GPS) location of the user equipment.

16. The non-transitory computer-readable storage medium of claim 13, wherein determining that roaming is allowed for the first transmitting device includes:
determining an organization identifier that identifies the first organization; and
comparing the determined organization identifier against the data structure to determine that roaming is allowed for the first organization to the second organization.

17. The non-transitory computer-readable storage medium of claim 16, wherein determining that roaming is allowed for the first transmitting device further includes:
determining that a roaming permission flag included in the first message indicates that roaming is allowed for the first transmitting device.

18. The non-transitory computer-readable storage medium of claim 16, wherein determining that roaming is allowed for the first transmitting device further includes:
determining that a plurality of roaming permission flags included in the first message indicate that roaming is allowed for the first transmitting device for the second organization.

19. The non-transitory computer-readable storage medium of claim 13, wherein determining that roaming is not allowed for the second transmitting device includes determining that a roaming permission flag included in the second message indicates that roaming is not allowed for the second transmitting device.

20. A user equipment (UE) for a crowdsourced Internet-of-Things (IoT) solution, the UE comprising:
a processor; and
a non-transitory computer-readable storage medium that provides instructions that, if executed by the processor, cause the UE to carry out operations including:
receiving, at the user equipment, a first message from a first transmitting device,
determining, from the first message, that the first transmitting device is associated with a first organization, and wherein the user equipment is associated with a second organization,
determining, using a data structure installed on the user equipment, that roaming is allowed for the first transmitting device from the first organization to the second organization, and responsive to this determination,
transmitting at least an identifier of the first transmitting device and location information of the user equipment to a roaming exchange for transmission to an Internet of Things (IoT) platform of the first organization,
receiving, at the user equipment, a second message from a second transmitting device,
determining, from the second message, that the second transmitting device is associated with a third organization, and
determining, using the data structure installed on the user equipment, that roaming is not allowed for the second transmitting device from the third organization to the second organization, and responsive to this determination, ignoring the received second message.

21. The user equipment of claim 20, wherein the first message is a first Bluetooth Low Energy (BLE) advertisement message, and wherein the second message is a second BLE advertisement message.

22. The user equipment of claim 20, wherein the location information includes a Global Positioning System (GPS) location of the user equipment.

23. The user equipment of claim 20, wherein determining that roaming is allowed for the first transmitting device includes:
determining an organization identifier that identifies the first organization; and
comparing the determined organization identifier against the data structure to determine that roaming is allowed for the first organization to the second organization.

24. The user equipment of claim 23, wherein determining that roaming is allowed for the first transmitting device further includes:
determining that a roaming permission flag included in the first message indicates that roaming is allowed for the first transmitting device.

25. The user equipment of claim 23, wherein determining that roaming is allowed for the first transmitting device further includes:
determining that a plurality of roaming permission flags included in the first message indicate that roaming is allowed for the first transmitting device for the second organization.
